(19) United States
(12) Patent Application Publication
(10) Pub. No.: US 2011/0099799 A1
(43) Pub. Date: May 5, 2011

(54) ROLLER FINISHING MACHINE

(75) Inventors: Edward Jackson, Norfolk (GB); Timothy Jackson, Norfolk (GB)

(73) Assignee: Edward Jackson (Engineer) Limited, Norfolk (GB)

(21) Appl. No.: 12/935,933

(22) PCT Filed: Feb. 23, 2009
(86) PCT No.: PCT/GB2009/000769

§ 371 Date: Dec. 22, 2010

(30) Foreign Application Priority Data
Apr. 8, 2008 (GB) 0806353.9

(51) Int. Cl. B23P 19/04

(52) U.S. Cl. 29/724

(57) ABSTRACT

A paint roller finishing machine comprising: a rotatable roller spindle to receive, in use, a paint roller to be finished; a drive unit operably coupled to said spindle to rotate it, in use; two or more finishing tools, selected from the group comprising: a carding tool; a pile shear; a pile beveller; a roller core cutter; and a pile parter; each of said finishing tools being arranged around said roller spindle and configured to be reversibly moveable, in use, from a non-operational position to an operational position in which operational position the tool acts upon a paint roller to be finished; and wherein said drive unit is configured to rotate said spindle, in use, at a plurality of preset rotational speeds. In preferred embodiments, the drive unit runs at speeds in excess of 1000 rpm, and the paint roller finishing machine may have a paint roller loading actuator.

### FIELD OF THE INVENTION

The invention relates to finishing operations during the manufacture of paint rollers, especially of the kind comprising a pile, or nap, of fibres extending from a central cylindrical core. In particular, the invention relates to methods of carrying out these finishing operations, and machines adapted to carry out the methods.

### BACKGROUND

Paint rollers are of two basic configurations: those made of an absorbent material, such as open-cell foam rubber, and those having a pile, or nap, of fibres, either synthetic, or of a natural material such as lambswool. The present invention relates to the finishing of this latter type of paint roller. In manufacture, a sheet of material having the pile material is wound around a usually hollow core, often made of card or a plastics material such as polypropylene, PVC or a phenolic plastic. The pile material is usually wound in a spiral fashion, producing a pile-covered roller, often several metres in length, which we refer to as a “roller blank”. In order to produce the finished paint roller, a number of finishing operations then need to be carried out: The roller blank needs to be cut to length, according to the type of roller to be produced. These may typically be from perhaps 10 cm to 30 cm, depending on the application. The fibres constituting the pile of the roller blank also need to be carded, to align them, and so produce a nap that will allow paint to be applied evenly. In order to further enhance the quality of paint transfer, the nap is often trimmed, or sheared, to give an even length. For some applications, the pile adjacent the ends of the finished roller are also bevelled. Bevelling the ends of the pile leads to more consistent application of paint by the extremities of the roller when subsequently used.

Machines to carry out these individual operations have been developed over the years, and in their most advanced configuration (exemplified by the applicant's own machine, known as the HSF-series) comprise a turret arrangement of multiple spindles; one for each operation that is carried out on the roller blanks. A roller blank is loaded onto a spindle adjacent a tool such as a carding drum, the spindle being arranged to rotate at a speed appropriate for the carding operation. The carding is then carried out by bringing the carding drum into contact with the pile. After carding, the turret is rotated to bring the partly finished roller blank adjacent another tool, such as a pile shearer. The spindle is again arranged to rotate at a speed appropriate for the shearing operation, and the shearer is brought into contact with the roller to carry out this operation. The spindle is again indexed to a new position adjacent a further tool and thereafter, if needed, to further successive tools to carry out the complete chain of operations. The movement of the workpiece and spindles between such successive finishing tools is time consuming, and increases the complexity of finishing machines. The indexing can only be carried out at the rate of the slowest finishing operation. Furthermore, the successive indexing process can lead to misalignment of the partly finished rollers with the successive tools, potentially leading to a reduction in the quality of the finished roller.

In another known roller finishing machine, initially conceived in the 1970's by the applicant, and known as the CF-series, a single roller spindle is employed, onto which a roller blank is loaded, adjacent a fixed end-stop. A combined beveller (in the form of a V-shaper cutter) and knife wheel is arranged at a fixed distance from the end-stop, so determining the length of the finished roller to be produced. The V-shaped cutter removes pile from the end of the roller blank so giving the knife wheel access to the roller core, so that it may be cut. A carding drum is arranged to be moveable towards the roller blank to be finished. The roller spindle, carding drum, and bevel cutter are driven by the same constant-speed electric motor, via a pulley system. The pulley system provides a fixed ratio of rotational speeds for the three tools. Independent operational speeds for the various finishing operations cannot therefore be adjusted. Furthermore, the bevelling operation is essential to allow access for the knife wheel to the roller core.

It is amongst the objects of the present invention to attempt a solution to these and other problems.

### SUMMARY OF THE INVENTION

Accordingly, in a first aspect, the invention provides a paint roller finishing machine comprising: a rotatable roller spindle to receive, in use, a paint roller to be finished; a drive unit operably coupled to said spindle to rotate it, in use; two or more finishing tools, selected from the group comprising: a carding tool; a pile shear; a pile beveller; a roller core cutter; and a pile parter; each of said finishing tools being arranged around said roller spindle and configured to be reversibly moveable, in use, from a non-operational position to an operational position in which operational position the tool acts upon a paint roller to be finished; and wherein said drive unit is configured to rotate said spindle, in use, at a plurality of preset rotational speeds.

In preferred embodiments, speed variation on the spindle drive may be achieved by use of a variable speed electric motor. Alternatively, a mechanical gearing system may be employed. For example, an array of friction drive wheels, rotating at different speeds, that may be moved sequentially into position to vary the rotational speed of the spindle may be employed.

By employing a spindle drive operable at a plurality of rotational speeds, each finishing operation may be optimised at its maximum speed, and hence the limitation imposed by a turret-type finishing machine of only indexing spindles at a rate equivalent to the slowest finishing operation is removed, so producing a more efficient machine.

Preferably, one or more of said preset rotational speeds is in excess of 1000 rpm. More preferably one or more of said speeds is in excess of 2000 rpm, or even 3000 rpm. In this way, the spindle and roller blank may be spun at such a high speed as to discharge cut fibres from the roller blank.

In a second aspect, the invention provides a paint roller finishing machine comprising: a rotatable roller spindle to receive, in use, a paint roller to be finished; a drive unit operably coupled to said spindle to rotate it, in use; two or more finishing tools, selected from the group comprising: a carding tool; a pile shear; a pile beveller; a roller core cutter; and a pile parter; each of said finishing tools being arranged around said roller spindle and configured to be reversibly moveable, in use, from a non-operational position to an operational position in which operational position the tool acts upon a paint roller to be finished; and a paint roller loading actuator, to move a paint roller blank to be finished to a preset, and configurable, position relative to a finishing tool. Preferably, said paint roller loading actuator comprises an electrical linear servo-actuator.

Preferably also, in any machine of the second aspect, said drive unit is configured to rotate said spindle, in use, at a plurality of preset rotational speeds. Preferably also, one of said preset rotational speeds is in excess of 1000 rpm. More preferably one of said speeds is in excess of 2000 rpm, or even 3000 rpm.

In any aspect of the invention, it is also preferred that a plurality of said finishing tools is each independently driven. Preferably said finishing tools are driven by variable speed motors. In this way, each tool can be configured to run independently, and preferably at a rotational speed appropriate for the particular specification of roller to be finished.

Also in any aspect of the invention, it is also preferred that the machine further comprises a programmable controller, configurable to control the rotational speeds of said roller spindle and the movement of said finishing tools.

The use of a programmable controller allows a single machine to be configured (and re-configured) to provide a range of roller finishing operations dependent on required finishing specifications and e.g. material of construction of the roller blanks.

In any aspect of the invention where the machine comprises a paint roller loading actuator, it is further preferred that the machine further comprises a programmable controller, configurable to control the operation of said paint roller loading actuator. By use of such a programmable actuator, rollers of different length may be produced without mechanical re-configuration of the machine.

Also included within the scope of the invention is a paint roller finishing machine substantially as described herein, with reference to and as illustrated by any appropriate combination of the accompanying drawings.

### BRIEF DESCRIPTION OF THE DRAWINGS

The invention will be described with reference to the accompanying drawings, in which:

FIG. 1 is a perspective view of part of a roller finishing machine according to the present invention;

FIG. 2 is a cross-sectional view of a carding drum;

FIGS. 3a and 3b show, respectively, a cross-section and an elevation of a cutter;

FIG. 4 shows a perspective view of part of a roller finishing machine according to the present invention, showing operational and non-operational positions of finishing tools;

FIG. 5 shows a plan view of part of a roller finishing machine according to the present invention;

FIG. 6 shows an elevation of part of a roller finishing machine according to the present invention, showing operational and non-operational positions of finishing tools;

FIG. 7 shows an elevational cross-section of part of a roller finishing machine according to the present invention; and

FIG. 8 shows a perspective view of part of a roller finishing machine according to the present invention.

### DESCRIPTION OF PREFERRED EMBODIMENTS

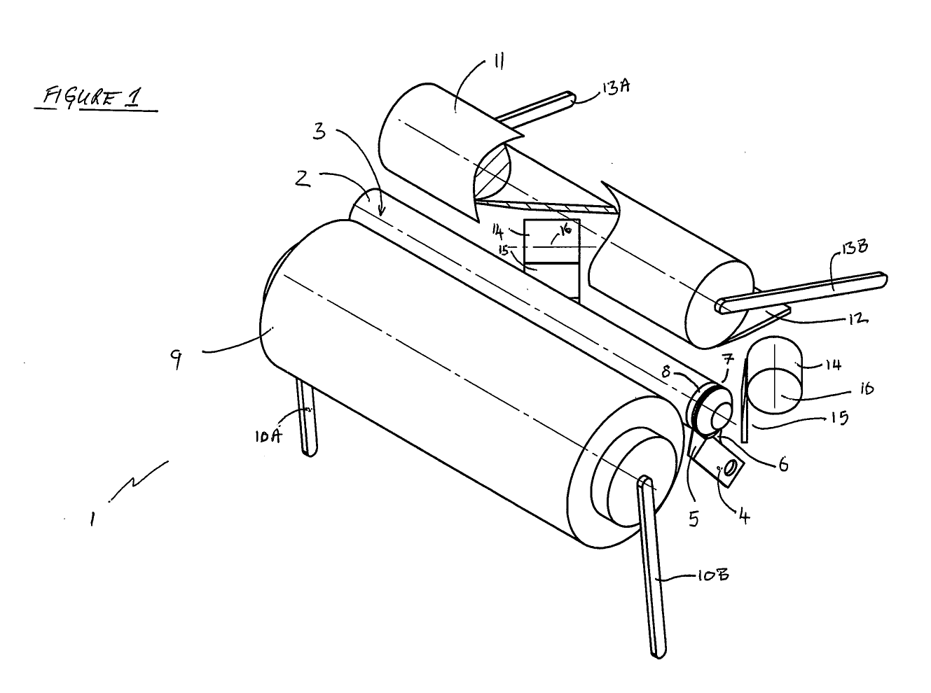

FIG. 1 illustrates, in schematic perspective view, a section of a roller finishing machine according to the present invention, and generally indicated by 1. The machine comprises a rotatable roller spindle 2 driven by an electric motor (not shown) to rotate about its axis illustrated by the chain dashed line 3. Located at one end of the roller spindle 2 is a parting tool 4, comprising a roller core cutter, or blade 5 and a pile parter 6. The parting tool 4 is swivelly mounted to allow the blade 5 to come into contact with the central core of a roller blank (not illustrated in FIG. 1) when located on the roller spindle 2. When the parting tool 4 is swivelled into its operational, cutting position as illustrated in FIG. 1, the pile parter 6 (which has the form of a beak) parts the pile on the roller blank to allow the blade 5 to contact the core of the roller blank and thereby cut it to the required length. Also located at this end of the roller spindle is a groove 7. The blade 5 is aligned with the groove 7 such that, when the blade has cut through the core of the roller blank, it can enter the groove 7, to produce a clean cut of the roller core.

Also in this embodiment, the roller spindle 2 is equipped with a roller blank gripping mechanism 8 that may be actuated to grip a roller by temporarily increasing the effective diameter of the roller spindle 2 in order to grip the inside of the roller blank core such that it rotates with the rotating roller spindle 2.

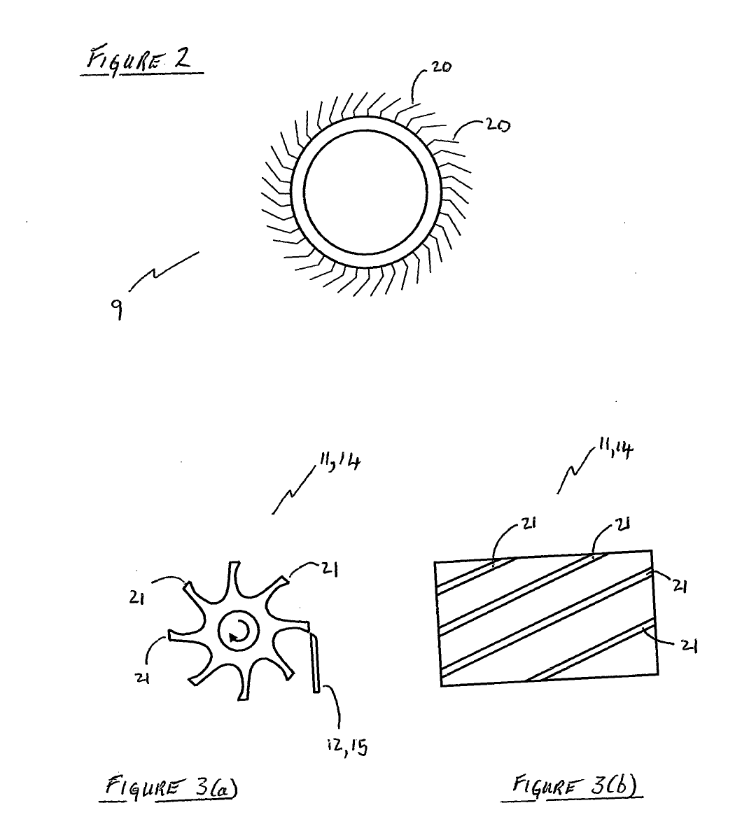

Located adjacent the roller spindle 2 is a carding drum 9. The surface of the carding drum 9 is covered with an array of carding wires (not shown in FIG. 1 for clarity, but illustrated in FIG. 2). The carding drum 9 is rotatably mounted on a pair of carder arms 10A, 10B. The carder arms 10 are themselves swivelly-mounted at their other ends allowing the carding drum 9 to be moved between a non-operational position into an operational position such that the carding wires are in contact with the pile of the paint roller. The carding drum itself 9 is also rotatably driven by another electric motor (not shown in FIG. 1) such that the carding drum rotates in the opposite sense to the roller spindle.

Alternate carding tools may be envisaged such as a flat sheet furnished with an array of protruding carding wires that may be brought into contact with a paint roller located on the roller spindle 2.

Also illustrated in FIG. 1 is a shear cutter 11 and a shear fixed blade 12 which together constitute the pile shear. Details of the blades of the shear cutter 11 are not illustrated in FIG. 1 for sake of clarity, but an example configuration of such a shear cutter is illustrated in FIG. 3. The shear cutter 11 is illustrated in part cut-away form, to allow the position of the second beveller to be seen. The shear cutter 11 is rotatably mounted on a pair of shear arms 13A and 13B, which are themselves swivelly mounted at a point away from the shear cutter 11, to allow the pile shear to be moved between a non-operational position away from a paint roller to be finished, to an operational position where the pile shear can trim the ends of the paint roller pile. Again, the shear cutter 11 is rotatably mounted on the shear arms 13 and is driven by an electric motor so the shear cutter 11 and the shear fixed blade 12 together serve to trim the ends of the pile fibres.

Also illustrated in FIG. 1 is a pair of bevellers, each comprising a bevel cutter 14 and a beveller fixed blade 15. The bevellers are located adjacent the roller spindle 2 with their axes of rotation (illustrated by lines 16) set at a required bevel angle to the axis of rotation 3 of the roller spindle 2. The bevel cutters are rotated by means of electric motors (not illustrated).

The bevellers are each mounted on actuators to move them from a non-operational position (not touching a roller blank located on the roller spindle 2) into an operational position where they progressively move towards the roller blank thereby bevelling the ends of the pile of the paint roller.

FIG. 2 illustrates, schematically, a cross-section through a carding drum 9, showing an array of carding wires 20 protruding from the surface of the carding drum 9.

FIG. 3A illustrates a cross-section through a cutter such as the pile shear cutter 11 or the beveller 14 of FIG. 1. FIG. 3B illustrates an elevation of such a cutter (with the fixed blade not shown, for clarity) and illustrating how the cutter has a series of spirally-located cutting edges 21 on its surface. These cutting edges 21 engage with the sharpened edge of the fixed blade 12, 15 to produce a shearing, or scissor-like action as the cutter 11, 14 is rotated, in use.

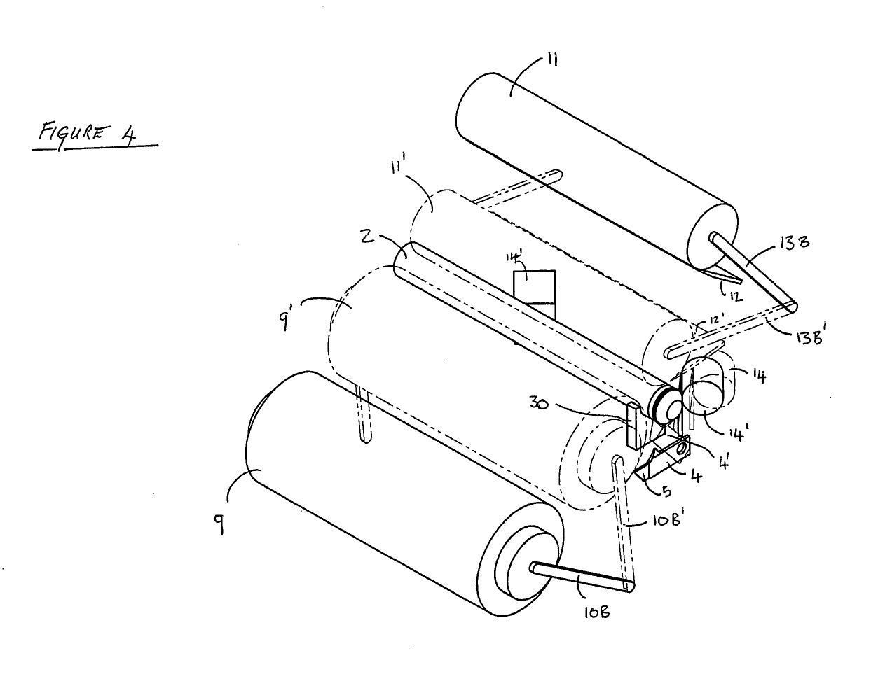

FIG. 4 illustrates, again in schematic perspective view, an arrangement of a paint roller finishing machine according to the present invention. At the centre of the device is the paint roller spindle 2 around which are arranged the various finishing tools, illustrated here in both their non-operational and operational positions. The carding drum 9, mounted on its arms 10 is illustrated in its non-operational position 9 and in dashed outline in its operational position 9′ and 10B′.

The pile shearer, comprising the cutter 11 and the shear fixed blade 12 is also illustrated in its non-operational position 11, 12 and in its operational position 11′, 12′.

The parting tool 4 is also illustrated in its non-operational position 4 and swivelled into its operational configuration 4′.

Also illustrated in FIG. 4 are the two bevellers 14, one of which is illustrated in its non-operational position 14 in dotted outline, and in its operational position 14′ in solid line.

Further illustrated in FIG. 4 an ejector 30 that is slidably mounted and arranged to move parallel to the axis of the roller spindle 2 to allow a finished paint roller to be ejected from the roller spindle 2.

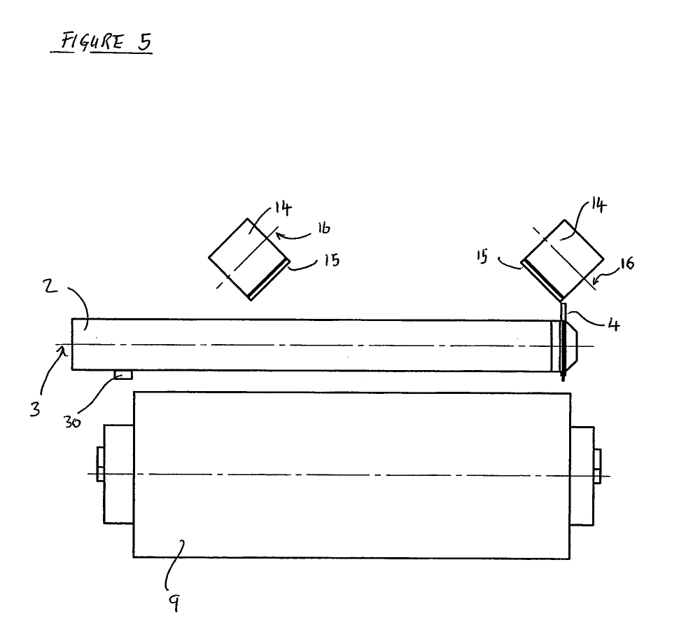

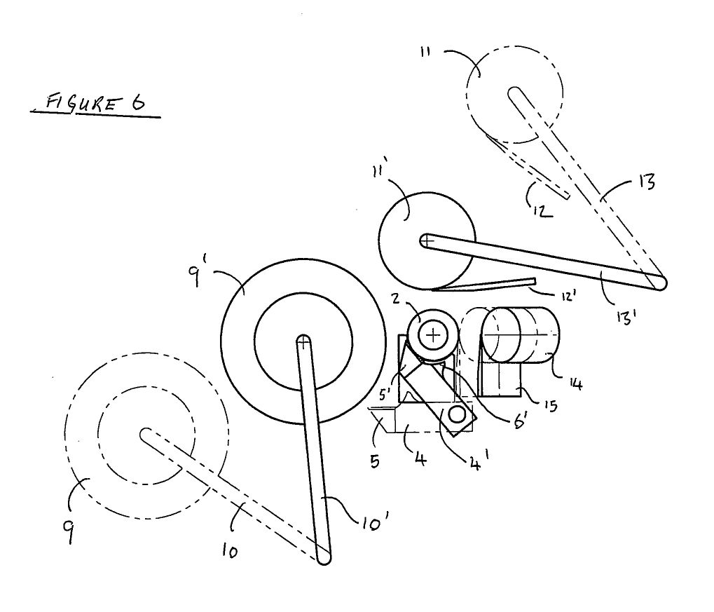

FIG. 5 illustrates in plan view an arrangement having a roller spindle 2 around which are located a carding drum 9, a pair of bevellers 14 and a parting tool 4. Also illustrated in this plan view is an ejector 30.

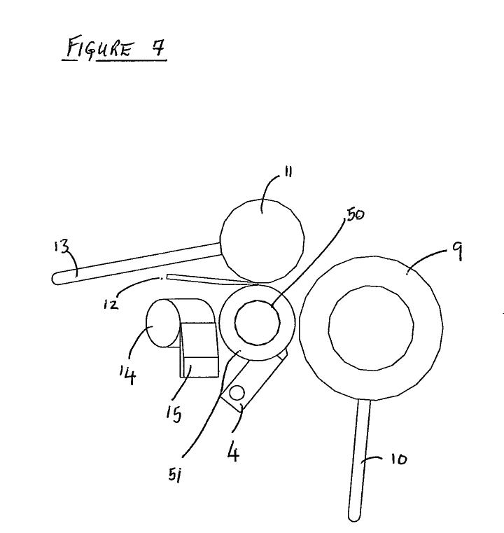

FIG. 6 illustrates a schematic side elevational view of a roller finishing machine according to the present invention illustrating the roller spindle 2 and a number of finishing tools. A parting tool 4 comprising a blade 5 and a pile parter 6 is shown in its non-operational configuration 4, 5 and in its operational configuration 4′, 5′, 6′ where it has been rotated in order to contact the roller blank.

Also illustrated is a carding drum 9 shown in its non-operational configuration 9, 10 in dashed outline and in its operational position 9′, 10′.

A shear cutter 11 is also illustrated, again in its non-operational position 11, 12, 13 in dashed outline, and in its operational position 11′, 12′, 13′.

Finally, a beveller comprising a bevel cutter 14 and a bevel cutter fixed blade 15 is also illustrated in its non-operational position (solid line) and in its operational position (dashed outline).

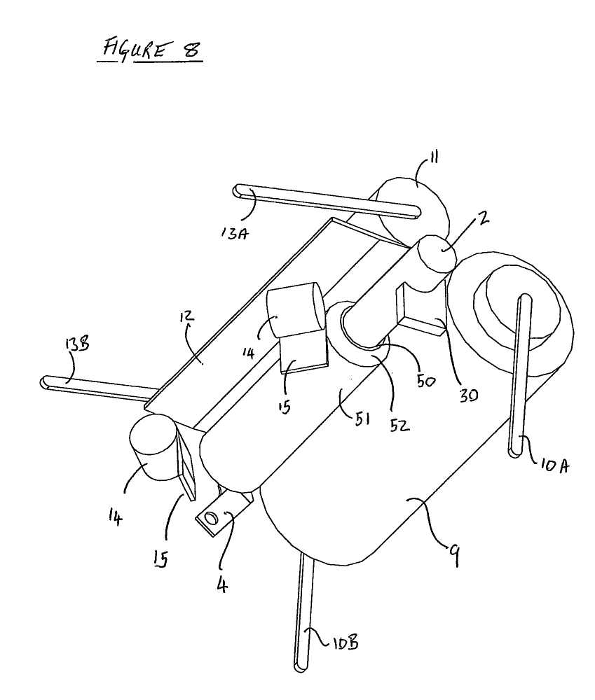

FIG. 7 illustrates in schematic elevational view a roller finishing machine according to the present invention with a selection of finishing tools in their operational positions. Mounted on the roller spindle (not illustrated) is a roller blank comprising a central core 50 and a pile covering 51. Illustrated in this view is the parting tool 4, a bevel cutter 14 and a beveller fixed blade 15. Located to one side is a carding drum 9 and located above the spindle is the pile shear cutter 11 with the shear fixed blade 12.

FIG. 8 illustrates, in perspective view, a roller finishing machine according to the present invention. The machine has a roller spindle 2 on which is located, in use, a roller blank, comprising a roller core 50 covered in a pile 51. The location of the bevel cutters 14 and the bevel fixed blades 15 is illustrated, as is a bevel 52 cut into the end of the pile 51 of the roller blank. A carding drum 9 and a pile shear cutter 11 are also illustrated.

At one end of the roller blank is the parting tool 4 and at the other end is the ejector 30 having the form of a block with a semi-circular cut-out to approximately match the outer diameter of the spindle 2. The ejector 30 is mounted on a slidable actuator (not illustrated) to allow it to move parallel to the axis of the roller spindle 2 to eject the roller blank (50, 51) from the spindle once finishing operations have been completed.

### METHOD OF OPERATION

Operating conditions for a typical roller finishing procedure are as follows:

Loading: A roller blank is loaded onto the roller spindle 2 by means of a paint roller loading actuator. Such an actuator may be provided in the form of an electrical linear servo-drive actuator. This allows for accurate, and programmable, positioning of the roller blank relative to the parting tool, so allowing a range of roller lengths to be produced without mechanically reconfiguring the machine. During this operation, the roller spindle may be stationary, or rotated slowly, e.g. at approximately 200 revolutions per minute (rpm) to facilitate loading of the roller blank. Once in position, the roller blank is held in place on the roller spindle 2 by means of a gripping mechanism. In particularly preferred embodiments, the mechanism operates by causing a section of the roller spindle to increase in effective diameter, so gripping the inside of the roller blank core. Means for achieving this include the provision of moveable sections of the roller spindle 2 that can be reversibly biased away from axis of revolution of the roller spindle by mechanical means in order to grip the inner surface of the roller blank core. The provision of knurling on the outer faces of these sections improves the grip on this inner surface. By preference, the gripping mechanism is located adjacent the parting tool, to reduce torsional stresses on the roller blank and to minimise wastage at the roller blank end.

Cutting: Once the roller blank is firmly located on the roller spindle 2, the parting tool 4 may be moved into its operational position. The pile-parter portion 6 of the parting tool 4 (in the form of a beak) eases the pile of the roller blank aside, allowing the blade 5 to access the surface of the roller blank core. As the parting tool 4 is driven towards the spindle 2, the spindle is typically rotated at approximately 800 rpm. Depending on the nature of the blade, or roller core cutter (which in some embodiments may itself be a rotating circular blade) the spindle rotation during this cutting operation may be within the range of 200-800 rpm. The cutting operation typically takes approximately 2-4 s to complete. Following cutting, the parting tool may be returned to its non-operational position.

Carding: Following the cutting operation, the parting tool is withdrawn into its non-operational position, and the carding drum 9 is moved into its operational position. During the carding operation, the speed of the roller spindle is adjusted typically to approximately 600 rpm. In particularly preferred embodiments of the invention, the rotational speed of the spindle (and also the rotational speed of the finishing tools) is programmable by means of a controller. A typical range for roller spindle speed rotation during the carding operation is 200-800 rpm. The carding drum 9 is also rotated, in the opposite direction to the roller spindle, and at a rate to give an approximately equal surface velocity of carding drum and roller blank. As the carding drum moves into its operational position, the carding wires 20 comb the pile to align the individual fibres. The carding operation typically takes 1-3 s to complete. Following carding, the carding drum is returned to its non-operational position.

Shearing: In order to cut the pile to an even length, usually following carding, the pile shear cutter 11 and its corresponding fixed blade 12 are moved into their operational positions. During this operation, the shear cutter is typically operated at a rotational speed of approximately 1200 rpm, whilst the roller spindle speed is reduced to 60-120 rpm. Again, in preferred embodiments of the invention, these speeds are under the control of a programmable controller. The shearing operation typically takes 1-3 s to complete. Following shearing, the shear cutter is returned to its non-operational position.

Bevelling: If it is required to bevel the ends of the pile, the bevel cutters 14 and their corresponding fixed blades 15 may be moved into their operational position. During this operation, the bevel cutter is typically operated at a rotational speed of approximately 1200 rpm, whilst the roller spindle speed is reduced to 60-120 rpm. Again, in preferred embodiments of the invention, these speeds are under the control of a programmable controller. The bevelling operation typically takes 1-3 s to complete. Following bevelling, the bevel cutter is returned to its non-operational position. Bevelling and shearing operations may, in preferred embodiments of the machine, be carried out simultaneously.

High Speed Spin: In order to eject any cut fibres from the trimmed pile, the workpiece may be subjected to a high speed spin. To achieve this, the rotational speed of the roller spindle is increased to 3000-6000 rpm. A suction tube may be provided to remove cut fibres and dust from the work area.

Workpiece Ejection: Following the required finishing operations, the finished roller may be ejected from the roller spindle by releasing the grip of the core gripping mechanism, and actuating the ejector 30, to push the finished piece from the roller spindle. During this ejection operation, the roller spindle is typically rotated at ca. 200 rpm.

It will be appreciated that some of these operations may be omitted, depending on the requirements for the finished paint roller. Also, the order of the finishing operations can be varied.

1. A paint roller finishing machine comprising:
a rotatable roller spindle to receive, in use, a paint roller to be finished;
a drive unit operably coupled to said spindle to rotate it, in use;
two or more finishing tools, selected from the group comprising:
a carding tool;
a pile shear;
a pile beveller;
a roller core cutter;
and a pile parter;
each of said finishing tools being arranged around said roller spindle and configured to be reversibly moveable, in use, from a non-operational position to an operational position in which operational position the tool acts upon a paint roller to be finished;
and wherein said drive unit is configured to rotate said spindle, in use, at a plurality of preset rotational speeds.

2. A paint roller finishing machine according to claim 1, wherein one or more of said preset rotational speeds is in excess of 1000 rpm.

3. A paint roller finishing machine comprising:
a rotatable roller spindle to receive, in use, a paint roller to be finished;
a drive unit operably coupled to said spindle to rotate it, in use;
two or more finishing tools, selected from the group comprising:
a carding tool;
a pile shear;
a pile beveller;
a roller core cutter; and
a pile parter;
each of said finishing tools being arranged around said roller spindle and configured to be reversibly moveable, in use, from a non-operational position to an operational position in which operational position the tool acts upon a paint roller to be finished; and
a paint roller loading actuator, to move a paint roller blank to be finished to a preset, and configurable, position relative to a finishing tool.

4. A paint roller finishing machine according to claim 3 wherein said paint roller loading actuator comprises an electrical linear servo-actuator.

5. A paint roller finishing machine according to claim 3, wherein said drive unit is configured to rotate said spindle, in use, at a plurality of preset rotational speeds.

6. A paint roller finishing machine according to claim 5 wherein one of said preset rotational speeds is in excess of 1000 rpm.

7. A paint roller finishing machine according to claim 1 wherein a plurality of said finishing tools is each independently driven.

8. A paint roller finishing machine according to claim 1 further comprising a programmable controller, configurable to control the rotational speeds of said roller spindle and the movement of said finishing tools.

9. A paint roller finishing machine according to claim 3, further comprising a programmable controller, configurable to control the operation of said paint roller loading actuator.

10. (canceled)
